(19) United States
(12) Patent Application Publication
(10) Pub. No.: US 2013/0085819 A1
(43) Pub. Date: Apr. 4, 2013

(54) METHOD OF MANAGING A DRIVER REWARDS PROGRAMME AND A SYSTEM THEREFOR

(71) Applicants: Adrian Gore, Sandton (ZA); Barry Swartzberg, Sandton (ZA)

(72) Inventors: Adrian Gore, Sandton (ZA); Barry Swartzberg, Sandton (ZA)

(73) Assignee: DISCOVERY HOLDINGS LIMITED, Sandton (ZA)

(21) Appl. No.: 13/641,155

(22) PCT Filed: Apr. 14, 2011
(86) PCT No.: PCT/IB2011/051626

§ 371 Date: Dec. 14, 2012

(30) Foreign Application Priority Data
Apr. 14, 2010 (ZA) 2010/02598
Jul. 28, 2010 (ZA) 2010/05379
Aug. 3, 2010 (ZA) 2010/05533
Feb. 16, 2011 (ZA) 2011/01241

(51) Int. Cl. G06Q 30/02

(52) U.S. Cl. CPC G06Q 30/02
USPC 705/14.1

(57) ABSTRACT

A method and system for managing a driver rewards programme includes receiving data including information relating to the compliance of a driver in at least one of a plurality of programme areas related to motor vehicle driver behaviours and storing the data in a database. Points are awarded to the driver wherein the points awarded are related to the compliance of the driver in the at least one programme area. Finally, the points awarded are used to determine a reward for the driver wherein the reward is a fuel related reward.

### BACKGROUND OF THE INVENTION

The present invention relates to a method of managing a driver rewards programme and a system therefor.

Drivers of motor vehicles are not motivated in any meaningful way to improve their driver behaviours thereby aiming toward safer driving.

The present invention seeks to address this.

### SUMMARY

According to one example embodiment there is provided a method of managing a driver rewards programme, the method including:
receiving data including information relating to the compliance of a driver in at least one of a plurality of programme areas related to motor vehicle driver behaviours and storing the data in a database;
awarding points to the driver wherein the points awarded are related to the compliance of the driver in the at least one programme area; and
using the points awarded to determine a reward for the driver wherein the reward is a fuel related reward.

In one example, the fuel related reward is a refund on fuel already consumed by a motor vehicle.

Alternatively or in addition, the fuel related reward is a payment towards a future purchase of fuel for use in a motor vehicle.

Alternatively or in addition, the fuel related reward is an amount of fuel for use in a motor vehicle.

The method may further include transmitting data to a third party server thereby to implement the fuel related reward, wherein the third party server is a server of a financial institution to arrange a payment to the driver or wherein the third party server is a server of a fuel supplier and the method includes instructing the supplier to supply the driver with fuel for no charge or at a reduced rate.

In one embodiment, the method further includes accessing insurance data stored in a database to determine if in addition to the motor vehicle there is at least one other item insured in the same or a related insurance policy and using this when determining the fuel related reward in that the fuel related reward will be greater if there is at least one other item insured in the same or a related insurance policy.

The points awarded may be used to determine a driver status, wherein the driver status is used to determine the fuel related reward for the driver.

The plurality of programme areas may include at least some of vehicle maintenance, driver education, vehicle insurance claims and driving performance or all of vehicle maintenance, driver education, vehicle insurance claims and driving performance.

The programme area of vehicle maintenance may include one or more of servicing the vehicle, checking the vehicle and checking the vehicles tyres.

The programme area of driver education may include one or more of a driving course, a driver assessment, a periodic driver quiz and a carbon footprint calculation.

The programme area of vehicle insurance claims may include the number of claim free periods.

The programme area of driving performance may include monitoring the manner in which a motor vehicle is driven.

In one example, the monitoring of the manner in which the motor vehicle is driven includes:
obtaining data from a device associated with a motor vehicle; and
analysing the data to determine the manner in which the motor vehicle has been driven for a past period.

According to another example embodiment there is provided a system for managing a driver rewards programme, the system including:
a receiving module for receiving data relating to the compliance of a driver in at least one of a plurality of programme areas related to motor vehicle driver behaviours;
a calculation module to award points to the driver wherein the points awarded are related to the compliance of the driver in the at least one programme area; and
a calculation module for calculating a reward for the driver wherein the reward is a fuel related reward for the motor vehicle.

The calculation module may further access insurance data stored in a database to determine if in addition to the motor vehicle there is at least one other item insured in the same or a related insurance policy and uses this when determining the fuel related reward in that the fuel related reward will be greater if there is at least one other item insured in the same or a related insurance policy.

The calculation module may use the points awarded to determine a driver status, wherein the driver status is used to determine the reward for the driver.

The system may further include:
the receiving module obtains driver data from a device associated with a motor vehicle; and
the analysing module analyses the data to determine the manner in which the motor vehicle has been driven for a past period.

### BRIEF DESCRIPTION OF THE DRAWINGS

FIG. 1 illustrates an example system environment in which an example embodiment is implemented;

FIG. 2 is a block diagram illustrating an example system to implement the methodologies described herein; and

FIG. 3 is a block diagram illustrating an example embodiment method.

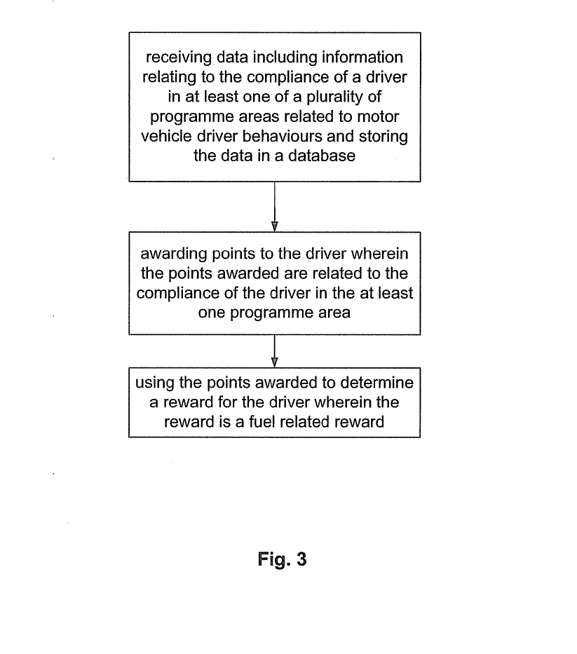

### DESCRIPTION OF EMBODIMENTS

The present invention relates to a method of managing a driver rewards programme and a system therefor.

Various insurance schemes are known to insure motor vehicles in the event of an accident or against theft, for example.

These insurance schemes typically have the owner of the motor vehicle as the insured person. The insured person pays a premium to the insurer to insure the motor vehicle against an insured event such as an accident or against theft, for example.

The quantum of the premium is usually determined using a number of factors such as the value of the motor vehicle and in certain cases the driver's age.

The above factors are also used to determine an excess which is a first amount paid by the insured person in the event of a claim before the insurer pays towards the claim.

However, these insurance schemes do not take into account driver behaviour nor vehicle mechanical condition in any meaningful way.

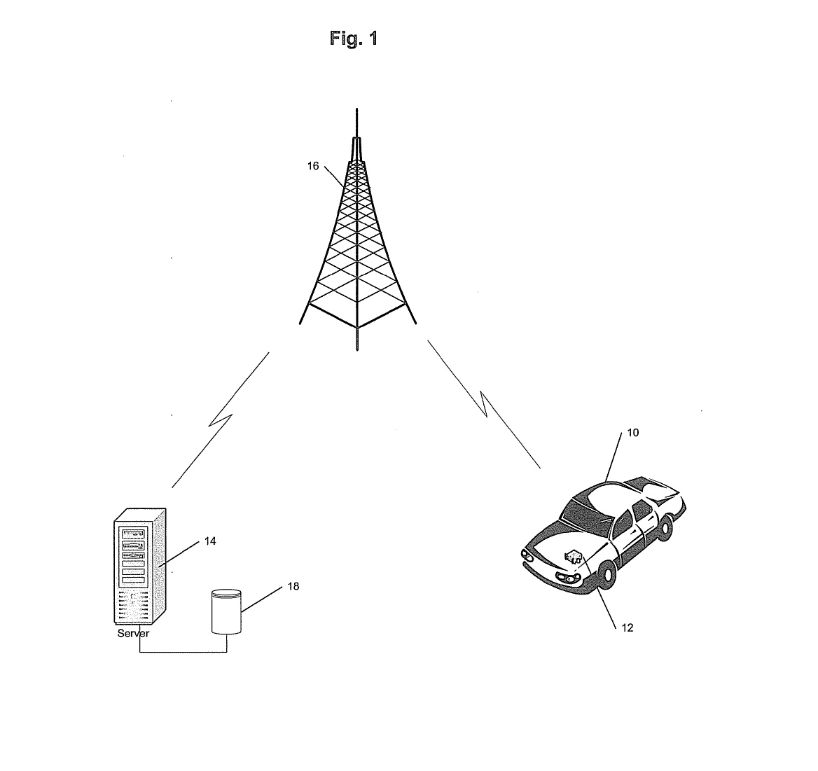

A system and method for addressing this is described below. p Referring to FIG. 1, a motor vehicle 10 has a telemetry device 12 associated therewith.

The telemetry device 12 is used to monitor a number of aspects of the use of the motor vehicle.

For example, the device monitors the speed at which the vehicle is travelling and can therefore calculate average speed and maximum and minimum speeds, for example.

Where the device includes GPS functionality, for example, the device is able to determine if speed limits on a particular road have been exceeded.

The device is also able to determine braking habits of the driver either using the GPS functionality or by using an accelerometer or having one or more sensors connected to the vehicle or to a deceleration detection device, for example.

The device is also typically able to detect the distance travelled and if the driver has driven the vehicle for a long time period without a break.

In addition, the times of the day that the vehicle is being driven can be captured as night time driving is statistically more dangerous than day time driving, especially weekend late night driving.

In addition to the above, the device will have the ability to detect the driver's use of the vehicle including braking, indicating and accelerating to name a few examples. Thus it could be determined when the vehicle turns without indicating, for example.

In any event, the data from the device is transmitted to a server 14 over a communication network 16.

It will be appreciated that this could be accomplished in a number of ways. For example, the data could be transmitted via a communication network 16 as illustrated in the accompanying drawing. This communication network could be any suitable kind of communication network such as a mobile communication network, a wireless communication network, a satellite communication network or a combination of these to name but a few examples.

Alternatively, the device 12 could be connected to another intermediate device which downloads the data and transmits the data via the communication network 16 to the server 14. One example of this could be connecting the device 12 to a USB port of a computer and downloading the data to the computer, which data is then transmitted over the Internet to the server 14.

In one example embodiment, the data is transmitted over a mobile phone network using the short message service (SMS) protocol.

It will be appreciated that the data could be transmitted at any suitable time to the server. For example, the data could be transmitted in real time or near real time or could be transmitted periodically such as daily, weekly or monthly to name a few examples.

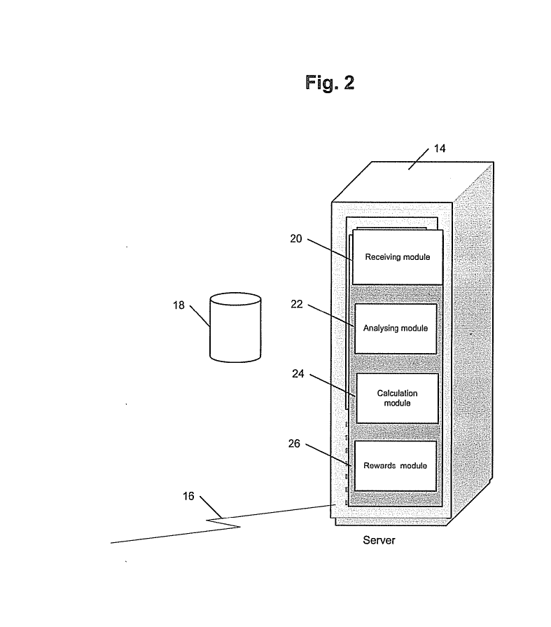

Referring to FIG. 2, an information processing system includes a server 14 that includes a number of modules to implement the present invention.

In one example embodiment, the modules described below may be implemented by a machine-readable medium embodying instructions which, when executed by a machine, cause the machine to perform any of the methods described above.

In another example embodiment the modules may be implemented using firmware programmed specifically to execute the method described herein.

It will be appreciated that embodiments of the present invention are not limited to such architecture, and could equally well find application in a distributed, or peer-to-peer, architecture system. Thus the modules illustrated could be located on one or more servers operated by one or more institutions.

It will also be appreciated that in any of these cases the modules form a physical apparatus with physical modules specifically for executing the steps of the method described herein.

In the illustrated example embodiment, the server 14 includes a receiving module 20 to receive the data and to write the data to a memory 18.

The memory 18 is typically in the form of a database 18 associated with the server 14.

Once the server 14 receives the data it will analyse the data to determine the manner in which the motor vehicle has been driven for a past predetermined period.

To do this the server includes an analysing module 22 which access the memory 18 and retrieves the data stored therein.

The retrieved data is then used to calculate a number of factors depending on the requirements of the insurers.

For example, the data received from the device may include one or more of speed related data, time of day or night data indicating what time the vehicle is driven, duration information data relating to the duration of time that the vehicle is driven without the driver thereof taking a break and distance information data including the distance that the vehicle travels over a period of time such as a month.

The speed related data may include one or more of the average speed that the vehicle is driven and the number of times that the vehicle exceeds a speed limit on a road on which the vehicle is travelling.

A calculation module 24 uses the analysed data to determine one or more fuel related rewards payable to the owner of the motor vehicle to the insurer.

The fuel could be petrol or diesel to name but two non-limiting examples.

In one example embodiment points are awarded to each of a number of sub-categories. Thus, points are awarded to the sub-category of speed which points are then used to determine an overall score. It will be appreciated that the scoring could be arranged that a higher score is a successful score or that a lower score is a successful score. In the illustrated embodiments described herein a higher score will be deemed a better score than a lower score.

Thus using the example of speed, the driver is awarded an amount of points if they never exceed the speed limit. Every infraction of the speed limit would result in a loss of points.

Similarly, for example, no night driving would result in a maximum score whilst a large amount of night driving would result a zero or even a minus score.

The method may further include motivating the driver to improve in other driver related behaviours.

In one example embodiment, this is implemented as follows.

The receiving module 20 receives compliance data containing information relating to the compliance of a driver in at least one of a plurality of programme areas related to motor vehicle driver behaviour.

The compliance data is stored in the database 18.

The analysing module 22 analyses the compliance data to determine driver behaviour.

The calculation module 24 awards points to the driver wherein the points awarded are related to the compliance of the driver in one or more of the programme areas. An example of this is described below.

Finally, the points awarded are used by a rewards module 26 to determine a fuel related reward for the driver which will also be described in more detail below.

The plurality of programme areas includes at least some of vehicle maintenance, driver education, vehicle insurance claims, premium payments, policy updates and driving performance.

In one example embodiment, the plurality of programme areas includes all of the abovementioned programme areas.

The programme area of vehicle maintenance includes one or more of servicing the vehicle, checking the vehicle and checking the vehicles tyres.

Describing these programme areas in more detail, servicing the vehicle means that the driver has taken the vehicle to a mechanical workshop for a periodic service to ensure that the vehicle is in good working order. Typically in such services oil and other lubricants are changed, brake pads are changed if required and any other mechanical faults that have arisen in the past period are fixed.

The programme area of checking the vehicle entails taking the vehicle to an authorised centre were a number of checks on the different parts of the vehicle are conducted to ensure that the vehicle is in good working order. If anything is found to be not correct, the driver will be instructed to take the vehicle to a workshop for fixing and may be awarded further points for this step.

New vehicles may be exempt from the service check for the first year and the insured person will be awarded these points on submission of proof that the vehicle is within its first year since its first registration.

Checking the vehicle tyres entails either having the tyres checked as part of the above-mentioned checking of the vehicle or alternatively, taking the vehicle to a specialist tyre centre to have the tyres checked.

In one example embodiment, an interface is created between the server 14 and checking centre via the communications network 16 so that the checking centre can confirm the results of the check.

In addition to the tyre check the steering, windscreen wipers, lights, seatbelts, hooter and shock absorbers can be checked at this time.

Bonus Points can be awarded for all of these being in an acceptable condition.

In all of these cases, the party doing the checking or servicing will capture data relating to the vehicle and/or driver and periodically transmit this data to the receiving module 20.

The programme area of driver education includes one or more of a driving course, a driver assessment, a periodic driver quiz and a carbon footprint calculation.

Driving courses are attended by drivers to improve their driving skills and particularly to learn so-called defensive driving skills.

A driver assessment is conducted in one example embodiment by an assessor taking the driver in the vehicle onto the road and assessing the driving skills and habits of the driver.

Weaknesses in the skills or habits of the driver may be pointed out and the driver given the opportunity to correct these in the coming weeks or months before returning for an updated assessment.

In one example, the driver is given an assessment score.

In another example, the driver assessment is an online questionnaire designed to highlight certain risks relating to a driver.

In this example, the questionnaire includes two sections namely. ‘Driving habits’ and ‘State of Vehicle’. For example a question of whether one uses a cellular telephone to send messages while driving will be asked. At the end of the questionnaire (approximately 20 questions) the driver will receive feedback explaining their risk and suggesting ways to mitigate their risks.

Based on the answers received a calculation will be performed to consider the driver's risk relative to an average driver. The results can be illustrated to the driver on two risk bars. One illustrates how risky the driver's habits are, and one illustrates risks relating to the state of the drivers vehicle.

A third risk bar may also be included illustrating a combined risk score.

In addition, the questionnaire may include educational information to address specific areas such as how to drive in wet weather or what to do in the event of an accident. The format will be a paragraph followed by a question relating to the paragraph

In this example, the driver will typically use a user interface device in the form of a computer with a screen on which is displayed a template for the driver to capture answers to questions put to them.

The answers are captured and transmitted to the server 14.

Alternatively, the server 14 accesses driver information stored in the database 18 and obtains the driver's e-mail address.

An e-mail is then sent to the retrieved e-mail address. When the driver opens the e-mail a template is displayed to them asking them the relevant questions with options to select various scores.

A driver will send the e-mail back to the server 14 via a communications network and the receiving module 20. These will be received and written to the database.

The programme area of premium payments relates to the quantum and frequency with which the premium payments are made and if they are made on time or not and the programme area of policy updates relates to whether or not the insured person is updating their policy to accurately reflect what is being insured by the insured person.

The programme area of vehicle insurance claims includes the number of claim free periods, for example years, on a motor vehicle insurance policy. No fault claims where the driver was not at fault typically will not be calculated as a claim for this.

The programme area of driving score includes monitoring the manner in which the motor vehicle is driven as has been described above.

An example of how the calculation module 20 then awards points is as follows:

| | Driver Category | Points | Frequency |
|---|---|---|---|
| Driving score | No Star (no telematics device) | | |
| | * | — | |
| | ** | 100 | Monthly |
| | *** | 350 | |
| | **** | 800 | |
| Road worthy | Annual Service | 50 | |
| | Multi Point Check | 50 | Annual |
| | Multi point check bonus points | 100 | |
| Education | Defensive driving course | 150 | Every 3 |
| | | | years |
| | Driver Assessment | 50 | Annual |
| | Quarterly quiz | 75 | ¼ly |
| | Carbon footprint calculated | 50 | Monthly |
| Claim | 1 | 25 | |
| Free | 2 | 50 | Monthly |
| Years | 3+ | 100 | |

It will be appreciated that the actual number of points allocated may change and other categories may be introduced.

In one example embodiment the number of points is used to determine a driver status. An example driver status is as follows:

| Driver Status | |
|---|---|
| Red | 0 |
| Amber | 300 |
| Green | 600 |
| Double Green | 1000 |

It will be appreciated that the way in which the points are allocated and driver status determined could be varied. However, in an example embodiment the status will be determined periodically, for example every month.

At the beginning of every calendar month the driver's points are zeroed and drivers will then be awarded points for having done a multi point check, annual service, driver assessment or carbon footprint calculation within the previous 12 months.

Similarly quarterly quiz points will be awarded provided the questionnaire has been done for that quarter.

Defensive driving courses need to be completed every 3 years or any other specified period to earn points and if a defensive driving course has been completed in the past 3 years then the relevant points will be added to the driver score for the present month.

If confirmation of these point earning events are received midmonth then points will be awarded immediately therefore contributing to the driver status in that month.

On the last day of each month the driver's telematic data or a telematic score will be received and points award points accordingly.

If multiple vehicles are insured then one method of dealing with this is to use a weighted average to calculate a single score calculated.

This will complete the driver's points for the month which will be added together to get the driver status for that month.

The driver status and individual driver telematic scores are communicated to the principle drivers via the communication network 24 as well as the policy holder where the policy holder is different to the driver.

In addition, reminders are sent out when a roadworthy check or tyre check is required via the communication network 24.

The method may further included the calculating module 24 accessing insurance data stored in the database 18 to determine if in addition to the motor vehicle there is at least one other item insured in the same or a related insurance policy and using this when determining the reward in that the reward will be greater if there is at least one other item insured in the same or a related insurance policy. This will be described in more detail below.

In one example, the fuel reward is then determined based on the driver category.

In one example embodiment, the fuel related reward is a fuel cash back where the amount of fuel spend in a prior period is paid back to the insured person. This can either be paid back to a bank account of the insured person or in a preferred embodiment a credit is issued to a credit or debit card that the insured person has used to purchase fuel.

In one example embodiment, analysing module 22 accesses data stored on the database 18 relating to historic fuel spend using a credit or debit card.

This information is typically obtained from the financial institution that issued the credit or debit card.

Another method of calculating the historic fuel spend if the driver does not want a card or does not qualify for one is that they can opt for a “Mileage and Consumption” version. The same rebate table will apply. The mileage driven will be derived from the telematics data. A generally-accepted consumption table will then be used to approximate “Litres consumed” and the calculation module 24 will calculate the reward value. The reward will be paid into the owner's nominated bank account.

In any event, the historic spend could be for a calendar month period, for example, but it will be appreciated that this could be any period of time. In this example, the driver of the motor vehicle will then receive a monthly fuel based reward.

The calculation module 24 then uses this to calculate the reward to the driver and an example is set out in the table below:

SUPPORTED MOTOR
REWARD AS A REBATE PER LITRE

| | |
|---|---|
| | POLICY DURATION |
| DRIVER | (complete years) |

| CATEGORY | 0 | 1 | 2 | 3+ |
|---|---|---|---|---|
| Red | | | | |
| Amber | 0.50 | 0.50 | 0.50 | 0.50 |
| Green | 1.00 | 1.00 | 1.25 | 1.50 |
| Double | 1.50 | 2.00 | 3.00 | 4.00 |
| Green | | | | |
| Triple Green | 2.00 | 3.00 | 5.00 | 7.50 |

Where “supported” means that in addition to the motor vehicle there is at least one other item insured in the same or a related insurance policy.

In the above table the driver of the motor vehicle will be given a rebate per litre used in a past period based on their driver category and on the number of years the motor vehicle has been insured on the policy. The rebate shown is an example of Rand/Litre but it will be appreciated that any suitable rebate could be selected.

If in addition to the motor vehicle there is no other item insured in the same or a related insurance policy then the motor vehicle insurance policy is defined as “unsupported” and the rebate table changes to the table below. It will be appreciated that the numbers in this table are lower than the numbers in the table above.

UNSUPPORTED MOTOR
REWARD AS A REBATE PER LITRE

| | |
|---|---|
| | POLICY DURATION |
| DRIVER | (complete years) |

| CATEGORY | 0 | 1 | 2 | 3+ |
|---|---|---|---|---|
| Red | | | | |
| Amber | | | | |
| Green | 0.50 | 0.50 | 0.50 | 0.50 |
| Double | 1.00 | 1.00 | 1.25 | 1.50 |
| Green | | | | |
| Triple Green | 1.50 | 2.00 | 3.00 | 4.00 |

Once the correct reward has been determined, a rewards module 26 then effects the reward. In one example embodiment this could be done by communicating with a financial institution via the communications network 16 and instructing the financial institution to implement the reward.

Typically the financial institution will be instructed to pay an amount of funds to the driver.

If the driver has a debit or a credit card that they use to purchase fuel then the financial institution is able to pay the rebate back to the debit or credit card as a credit amount that will show on the card.

In one example embodiment the driver is issued with a debit or a credit card when they take out insurance on their motor vehicle and this is then used as the mechanism to pay them their fuel related reward.

The fuel related reward may be a refund on fuel already consumed by the motor vehicle as shown above. In other embodiments, the fuel related reward may be a payment towards a future purchase of fuel for use in the motor vehicle, alternatively or in addition the fuel related reward may be an amount of fuel for use in the motor vehicle.

Alternatively or in addition the third party server may be a server of a fuel supplier instructing the supplier to supply the owner of the motor vehicle with fuel for the motor vehicle for no charge or at a reduced rate.

In one example embodiment, any claims on the insurer will be taken into account when determining the rebate.

For example, half the applicable rebate (50%) will be payable in the event of 1 claim in the previous 12 months and no rebate (0%) will be payable in the event of more than 1 claim in the previous 12 months. The 12-month period refers to the 12 months preceding the reward calculation date (i.e. a rolling 12-month period).

In determining what claims have been made:
a. The reward for each vehicle will be linked to the claims experience of that particular vehicle only.
b. The reduction in benefit will apply from the month that a claim payment is made by the insurer. This refers to “indemnity” type claim payments only and excludes payments in respect of claim investigations. If the claim is finalised without any indemnity payment being made, the benefit will not be impacted.
c. If a claim is recovered from a third party, the benefit will recommence from the month it is recovered. If apportionment of fault relating to the owner is less than 50%, it will cease to count as a claim for the purpose of this calculation from the month of recovery. However, there will be no back-payment of any reward that may have been forfeited in the interim.
d. The following claim events will be excluded for the purpose of this reward:
   i.

Windscreen repair
ii. SASRIA
iii. VAPS (TBC)

No benefit will be payable if the insurance policy is “suspended” due to outstanding premium(s).

In one example implementation, the driver is given a non transactional magnetic or smart card which is swiped each time fuel is purchased at a fuel supplier.

The fuel supplier system identifies the driver and stores fuel purchase data relating to the fuel purchases in a database. The fuel purchase data is then transmitted to the receiving module 20 of the server 14.

Alternatively the fuel purchase data can be transmitted to the receiving module 20 directly without being stored in the database associated with the fuel supplier system.

In any event, it will be appreciated that in this embodiment there is no restriction on the method used to purchase the fuel i.e. the driver could pay with cash, credit card etc.

The driver is given a flat 10% rebate on fuel purchased but the discountable spend is limited to the number of points earned in the programme and hence the size of the benefit is directly related to the driver behaviors. For example, if a person earns 1,000 points in a month the rebate earned will be R100.

The driver may increase the percentage amount by engaging in specific predefined driver behaviours.

For example, if the driver has completed a tire check within the past year, the rebate increases to 25%.

In the above example, if the driver has earned 1,000 points and has completed a tire check the maximum discount will now become R250.

In addition, if the fuel is purchased using a predefined credit or debit card, an extra 15% rebate is given to the member.

The refund in this example embodiment is also limited to 50% of a monthly motor vehicle insurance premium.

Thus it will be appreciated that the present invention provides a method of rewarding the driver thereby motivating them to improve their driving skills and to look after their motor vehicle. This helps ensure the driver's safety while at the same time results in reduced claims to the insurer and is therefore beneficial to all parties.

In an extension to rewarding the driver of the motor vehicle, where the driver is also a member of a rewards programme such as the Vitality programme operated by the applicant, the driver is able to earn Vitality points for good driving habits.

An example of this is illustrated in the table below:

| Driver Status | |
|---|---|
| (6-monthly) | Vitality points |
| Red | 0 |
| Amber | 500 |
| Green | 1000 |
| Double Green | 2000 |
| Triple Green | 2500 |

1-28. (canceled)

29. A method of managing a driver rewards programme, the method including:
receiving, with a computer, data including information relating to compliance of a driver in at least one of a plurality of programme areas related to motor vehicle driver behaviours and storing the data in a computer database;
awarding points to the driver wherein the points awarded are awarded by the computer and are related to the compliance of the driver in the at least one programme area; and
using the points awarded to determine a reward for the driver wherein the reward is a fuel related reward.

30. A method according to claim 1 wherein the fuel related reward is a refund on fuel already consumed by a motor vehicle.

31. A method according to claim 1 wherein the fuel related reward is a payment towards a future purchase of fuel for use in a motor vehicle.

32. A method according to claim 29 wherein the fuel related reward is an amount of fuel for use in a motor vehicle.

33. A method according to claim 29 further including transmitting data to a third party server thereby to implement the fuel related reward, wherein the third party server is a server of a financial institution to arrange a payment to the driver.

34. A method according to claim 29 further including transmitting data to a third party server thereby to implement the fuel related reward, wherein the third party server is a server of a fuel supplier and the method includes instructing the supplier to supply the driver with fuel for no charge or at a reduced rate.

35. A method according to claim 29 further including accessing insurance data stored in a database to determine if in addition to the motor vehicle there is at least one other item insured in the same or a related insurance policy and using this when determining the fuel related reward in that the fuel related reward will be greater if there is at least one other item insured in the same or a related insurance policy.

36. A method according to claim 29 wherein the points awarded are used to determine a driver status, wherein the driver status is used to determine the fuel related reward for the driver.

37. A method according to claim 29 wherein the plurality of programme areas include at least some of vehicle maintenance, driver education, vehicle insurance claims and driving performance.

38. A method according to claim 29 wherein the plurality of programme areas include all of vehicle maintenance, driver education, vehicle insurance claims and driving performance.

39. A method according to claim 37 wherein the programme area of vehicle maintenance includes one or more of servicing the vehicle, checking the vehicle and checking the vehicles tires.

40. A method according to claim 37 wherein the programme area of driver education includes one or more of a driving course, a driver assessment, a periodic driver quiz and a carbon footprint calculation.

41. A method according to claim 37 wherein the programme area of vehicle insurance claims includes the number of claim free periods.

42. A method according to claim 37 wherein the programme area of driving performance includes monitoring the manner in which a motor vehicle is driven.

43. A method according to claim 42 wherein monitoring the manner in which the motor vehicle is driven includes:
obtaining data from a device associated with a motor vehicle; and
analysing the data to determine the manner in which the motor vehicle has been driven for a past period.

44. A computer system for managing a driver rewards programme, the system including:
a receiving module for receiving data relating to the compliance of a driver in at least one of a plurality of programme areas related to motor vehicle driver behaviours;
a calculation module to award points to the driver wherein the points awarded are related to the compliance of the driver in the at least one programme area; and
a calculation module for calculating a reward for the driver wherein the reward is a fuel related reward for the motor vehicle.

45. A computer system according to claim 44 wherein the fuel related reward is a refund on fuel already consumed by a motor vehicle.

46. A computer system according to claim 44 wherein the fuel related reward is a payment towards a future purchase of fuel for use in a motor vehicle.

47. A computer system according to claim 44 wherein the fuel related reward is an amount of fuel for use in a motor vehicle.

48. A computer system according to claim 44 wherein the calculation module further accesses insurance data stored in a database to determine if in addition to the motor vehicle there is at least one other item insured in the same or a related insurance policy and uses this when determining the fuel related reward in that the fuel related reward will be greater if there is at least one other item insured in the same or a related insurance policy.

49. A computer system according to claim 44 wherein the calculation module uses the points awarded to determine a driver status, wherein the driver status is used to determine the reward for the driver.

50. A computer system according to claim 44 wherein the plurality of programme areas include at least some of vehicle maintenance, driver education, vehicle insurance claims and driving performance.

51. A computer system according to claim 44 wherein the plurality of programme areas include all of vehicle maintenance, driver education, vehicle insurance claims and driving performance.

52. A computer system according to claim 50 wherein the programme area of vehicle maintenance includes one or more of servicing the vehicle, checking the vehicle and checking the vehicles tires.

53. A computer system according to claim 50 wherein the programme area of driver education includes one or more of a driving course, a driver assessment, a periodic driver quiz and a carbon footprint calculation.

54. A computer system according to claim 50 wherein the programme area of vehicle insurance claims includes the number of claim free periods.

55. A computer system according to claim 50 wherein the programme area of driving score includes monitoring the manner in which the motor vehicle is driven.

56. A computer system according to claim 50 further wherein:
the receiving module obtains driver data from a device associated with a motor vehicle; and
the analysing module analyses the data to determine the manner in which the motor vehicle has been driven for a past period.
